(19) United States
(12) Patent Application Publication
(10) Pub. No.: US 2005/0002096 A1
(43) Pub. Date: Jan. 6, 2005

(54) Screen, image display device and rear projector

(75) Inventors: Masatoshi Yonekubo, Hara-mura (JP); Tetsuro Yamazaki, Suwa-shi (JP); Takashi Takeda, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/854,709

(22) Filed: May 27, 2004

(30) Foreign Application Priority Data
May 29, 2003 (JP) 2003-153205

(51) Int. Cl. G03B 21/56

(52) U.S. Cl. 359/460

(57) ABSTRACT

To provide an image display device and a rear projector which are compact and light in weight and which can afford a large screen, and a screen which is well suited for them, a screen having a first surface which laser lights enter, and a second surface from which the laser lights exit, includes an illuminant for R light, an illuminant for G light, and an illuminant for B light, which generate the R light, G light and B light by being irradiated with the UV laser lights, respectively. The first surface includes openings which pass the UV laser lights therethrough so as to irradiate the illuminants for the respective colored lights, ,with the UV laser lights, and light shield portions provided at the peripheral parts of the openings in order to intercept the UV laser lights.

### BACKGROUND OF THE INVENTION

1. Field of Invention

The present invention relates to a screen, an image display device and a rear projector, and more particularly to an image display device and a rear projector which employ laser light.

2. Description of Related Art

A CRT (Cathode Ray Tube) is extensively utilized as an image display device. The CRT is constituted by glass, and has its interior held in vacuum (see Japan Broadcasting Corporation: “NHK COLOR TV TEXTBOOK (Upper Volume)”, First Edition, published by Japan Broadcast Publishing Co., Ltd. on Apr. 1, 1982, pp. 242-245).

### SUMMARY OF THE INVENTION

In recent years, it has been required to enlarge the screen and enlarge the size of an image display device. In case of enlarging the size of a related-art CRT, glass constituting the CRT, especially a vacuum tube becomes large, resulting in such problems that the weight of the CRT becomes heavy, and that a CRT display itself becomes large in size.

The present invention has been made in order to address the above problems. The present invention provides an image display device and a rear projector which are compact, are light in weight and can attain a large screen, and a screen which is well suited for the image display device and the rear projector.

In order to address the problems and to accomplish the above, according to an aspect of the present invention, there can be provided a screen having a first surface which laser lights enter, and a second surface from which the laser lights exit, including a plurality of illuminants for first colored light, which are irradiated with a first laser light of the laser lights, thereby to generate the first colored light in a first wavelength region; a plurality of illuminants for second colored light, which are irradiated with a second laser light of the laser lights, thereby to generate the second colored light in a second wavelength region different from the first wavelength region; the plurality of illuminants for the first colored light and the plurality of illuminants for the second colored light being alternately arrayed on the second surface; openings which are formed on the first surface, which pass the first laser light therethrough so as to irradiate the illuminants for the first colored light, and which pass the second laser light therethrough so as to irradiate the illuminants for the second colored light; and light shield portions which are provided at peripheral parts of the openings on the first surface so as to intercept the first laser light and the second laser light.

The illuminants for the first colored light are excited by the first laser light, thereby to generate the first colored light in the first wavelength region. An ultraviolet radiation region, a visible radiation region or an infrared radiation region can be employed for the wavelength of the laser light. The illuminants for the first colored light employ a substance which generates fluorescence, phosphorescence, or light based on a photoluminescent function, by being irradiated with the laser light. Likewise, the illuminants for the second colored light are excited by the second laser light, thereby to generate the second colored light in the second wavelength region. The first surface being the entrance surface of the screen, is formed with the openings which pass the first laser light therethrough so as to irradiate the illuminants for the first colored light, and which pass the second laser light therethrough so as to irradiate the illuminants for the second colored light. Further, the light shield portions to intercept the first laser light and the second laser light are provided in the peripheral regions of the openings. Thus, the first laser light or the second laser light can supply energy to the illuminants for the first colored light or the illuminants for the second colored light, merely by being caused to enter the openings. As a result, the first colored light or the second colored light can be generated. Accordingly, when the illuminants for the first colored light or the illuminants for the second colored light are to be irradiated with the first laser light or the second laser light, positioning can be easily performed.

According to an aspect of the present invention, a laser-light cutting filter may be disposed on an exit side of the illuminants for the first colored light and the illuminants for the second colored light, which absorbs or reflects the first laser light and the second laser light, and which transmits the first colored light and the second colored light therethrough. In some cases, the first laser light or the second laser light having entered the illuminants for the first colored light or the illuminants for the second colored light, respectively, further exits from the side of the second surface of the screen to the side of an observer. The laser lights exiting from the screen are lights which are unnecessary for image formation. Further, it is unfavorable from the viewpoint of safety that the laser lights exiting from the screen enter the field of view of the observer. In this aspect, the laser-light cutting filter stated above is disposed on the exit side of the illuminants for the first colored light and the illuminants for the second colored light.

Thus, the first colored light and second colored light can be caused to exit from the side of the second surface of the screen. The first laser light and second laser light can be prevented from exiting the screen.

According to an aspect of the present invention, a dichroic film may be interposed between the first surface and the second surface, which transmits the first laser light and the second laser light therethrough, and which reflects the first colored light and the second colored light generated toward the first surface, toward the second surface. The first colored light from the illuminants for the first colored light is generated, not only in the sense of exiting from the side of the second surface of the screen, but also in the sense of the first surface being the entrance surface. Likewise, the second colored light from the illuminants for the second colored light is generated, not only in the sense of exiting from the side of the second surface of the screen, but also in the sense of the first surface being the entrance surface. The first colored light and the second colored light generated toward the first surface do not exit to the side of the second surface of the screen, for example, the side of the observer, so that losses in the quantities of the lights occur. In contrast, in this aspect, a dichroic film is interposed between the first surface and the second surface. The dichroic film reflects the first colored light and second colored light generated toward the first surface, toward the second surface. Thus, the first colored light and second colored light can be effectively caused to exit from the side of the second surface. The dichroic film transmits the first laser light and the second laser light therethrough. Therefore, the first laser light and second laser light can be efficiently caused to enter the first illuminants and second the illuminants, respectively.

According to an aspect of the present invention, first colored lights may be red light and green light, while the second colored light is blue light. Thus, a fill-color image can be easily obtained.

According to an aspect of the present invention, it is possible to provide an image display device including a first laser light source which supplies the first laser light modulated in accordance with an image signal; a second laser light source which supplies the second laser light modulated in accordance with an image signal; a scanning portion which scans at least either of the first laser light and the second laser light within a two-dimensional plane; and a screen which is stated above. Thus, even in case of enlarging the size of the screen, it is unnecessary to employ a large and heavy CRT as in the related art. Therefore, the image display device which is compact and light in weight and which has a large screen can be obtained.

The scanning portion may include a first scanning portion which scans the first laser light, and a second scanning portion which scans the second laser light. Thus, the first laser light and the second laser light can be simultaneously scanned. As a result, a time period necessary to display a full-color image can be shortened. Moreover, each of the first scanning portion and second scanning portion can be made smaller in size, so that fast drive is realized.

According to an aspect of the present invention, it is possible to provide a rear projector including a first laser light source which supplies the first laser light modulated in accordance with an image signal; a second laser light source which supplies the second laser light modulated in accordance with an image signal; a scanning portion which scans at least either of the first laser light and the second laser light within a two-dimensional plane; a reflection mirror which reflects the scanned laser light; and a screen which is stated above, and which is irradiated with the laser light reflected by the reflection mirror.

In an aspect of the present invention, an optical path is bent by the reflection mirror which is interposed between the scanning portion and the screen. Thus, the distance between the scanning portion and the screen can be shortened. Therefore, the rear projector of small depth, compact structure and large screen can be obtained.

### BRIEF DESCRIPTION OF THE DRAWINGS

FIG. 1 is a schematic of an image display device according to the first exemplary embodiment of the present invention;

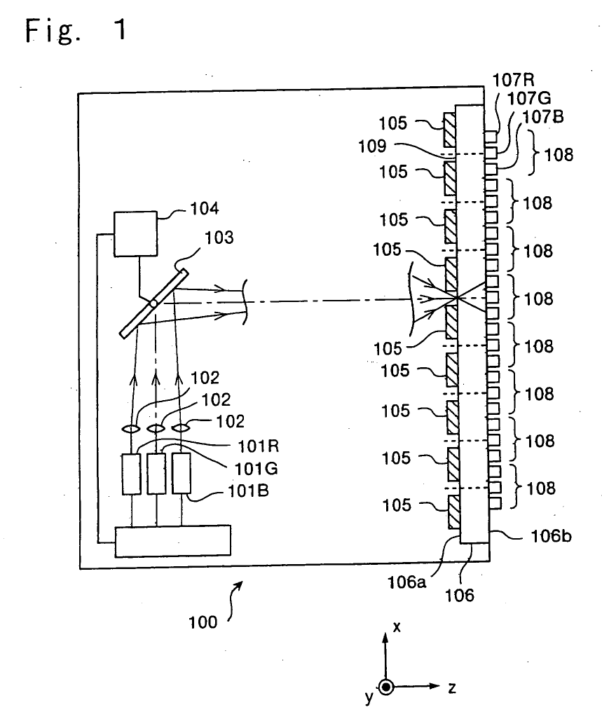

FIG. 2 is a schematic of a pixel array in the first exemplary embodiment;

FIG. 3 is a schematic of the first modification of the pixel array in the first exemplary embodiment;

FIG. 4 is a schematic of the second modification of the pixel array in the first exemplary embodiment;

FIG. 5 is a sectional schematic of a screen in the first exemplary embodiment;

FIG. 6 is a schematic of an image display device according to the second exemplary embodiment of the present invention;

FIG. 7 is a schematic of the modification of the second exemplary embodiment;

FIG. 8 is a schematic of an image display device according to the third exemplary embodiment of the present invention;

FIG. 9 is a schematic of an image display device according to the fourth exemplary embodiment of the present invention; and

FIG. 10 is a schematic of a rear projector according to the fifth exemplary embodiment of the present invention.

### DETAILED DESCRIPTION OF EXEMPLARY EMBODIMENTS

First Exemplary Embodiment

Now, an image display device 100 according to the first exemplary embodiment of the present invention will be described with reference to the accompanying drawings. This exemplary embodiment is the image display device in which a fluorophor is irradiated with ultraviolet (hereafter “UV”) laser lights, thereby to obtain red light (hereafter, “R light”), green light (hereinbelow, termed “G light”) and blue light (hereafter, “B light”). In the ensuing description, a first colored light in a first wavelength region will be the R light or the G light, and a second colored light in a second wavelength region will be the B light.

First, an optical path to obtain the R light will be described. A UV laser light source for-the R light, 1018 which is a first laser light source supplies a first laser light to obtain the R light which is the first colored light in the first wavelength region. A semiconductor laser or a solid-state laser which oscillates light of a wavelength in an ultraviolet region can be employed as the light source R of the UV laser 101 for the R light. The UV laser light for the R light, from the UV laser light source for the R light, 101R is transmitted through a condensing lens 102, and it enters a galvano-mirror 103 which is a scanning portion. A galvano-mirror drive portion 104 drives the galvano-mirror 103 so that the UV laser light for the R light may be scanned within a two-dimensional plane. The UV laser light for the R light as reflected by the galvano-mirror 103 proceeds toward a screen 106. The screen 106 has a first surface 106a which the UV laser light for the R light enters, and a second surface 106b from which the UV laser light for the R light exits.

The second surface 106b of the screen 106 is provided with a fluorophor for the R light, 1 0 7 R which is an illuminant for the first colored light. When irradiated with the UV laser light for the R light, the fluorophor for the R light, 1 0 7 R is excited by the energy of the laser light, thereby to generate the fluorescence of the R light being the first colored light in the first wavelength region. The first surface 106a of the screen 106 is provided with openings 109 for passing the UV laser light for the R light therethrough and irradiating the fluorophor for the R light, 1 0 7 R therewith. Further, the first surface 106a is formed with light shield portions 105 which are provided sideward of the openings 109 so as to intercept the UV laser light for the R light. The relationship between the openings 109 and the fluorophor for the R light, 107R will be explained later.

Next, an optical path for the G light will be described. A UV laser light source for the G light, 101G which is a first laser light source supplies UV laser light to obtain the G light which is the first colored light in the first wavelength region. The UV laser light source for the G light, 101G is a semiconductor laser or a solid-state laser which oscillates light of a wavelength in the ultraviolet region. The UV laser light for the G light, from the UV laser light source for the G light, 101G is transmitted through a condensing lens 102, and it enters the galvano-mirror 103 which is the scanning portion. It is scanned within the two-dimensional plane likewise to the UV laser light for the R light, from the UV laser light source for the R light, 101R. The scanned UV laser light for the G light passes through the openings 109, and thereafter enters fluorophor for the G light, 107G which is an illuminant for the first colored light. The fluorophor for the G light, 107G is excited by the energy of the UV laser light for the G light, thereby to generate the fluorescence of the G light being the first colored light in the first wavelength region.

Next, an optical path for the B light will be described. A UV laser light source for the B light, 101B which is a second laser light source supplies a UV laser light for the B light, to obtain the B light which is the second colored light in the second wavelength region. The UV laser light source for the B light, 101B is a semiconductor laser which oscillates light of a wavelength in the ultraviolet region, likewise to the UV laser light source for the R light, 101 R. The UV laser light for the B light, from the UV laser light source for the B light, 101B is transmitted through a condensing lens 102, and it enters the galvano-mirror 103 which is the scanning portion. The UV laser light for the B light is scanned within the two-dimensional plane likewise to the UV laser light for the R light, from the UV laser light source for the R light, 101R. The scanned UV laser light for the B light passes through the openings 109 of the screen 106, and thereafter enters a fluorophor for the B light, 107B which is an illuminant for the second colored light. The fluorophor for the B light, 107B is excited by the energy of the UV laser light for the B light, thereby to generate the fluorescence of the B light being the second colored light in the second wavelength region.

A control portion 110 controls the individual UV laser light sources 101 R, 101G, 101B so that the UV laser lights for the respective colored lights may be modulated in accordance with image signals. By way of example, the period of one frame of an image is configured of three time periods of equal intervals, which display the R light, G light and B light, respectively. The UV laser light sources for the colored lights, 1018, 101G, 101B are sequentially turned ON in the corresponding time periods, respectively. The UV laser lights for the respective colored lights as controlled in accordance with the image signals enter the openings 109 of the screen 106 as explained above. Herein, the fluorophors for the respective colored lights, 107R, 107G, 107B sequentially generate the fluorescences at intensities corresponding to the image signals. Thus, the image of the R light is displayed, and the image of the G light is thereafter displayed. Subsequently, the image of the B light is displayed after the display of the image of the G light. The display procedure of steps is iterated. An observer can obtain a full-color image in such a way that the images of the R light, G light and B light are respectively integrated temporally and recognized. Further, the UV laser light sources for the respective colored lights, 1018, 101G, 101B may, of course, may be always caused to emit the lights in accordance with image signals, so as to simultaneously display the R light, G light and B light. Herein, a vacuum tube of glass as in a CRT need not be employed, so that a compact and lightweight mechanism suffices even in case of enlarging the size of the screen 106.

Screen

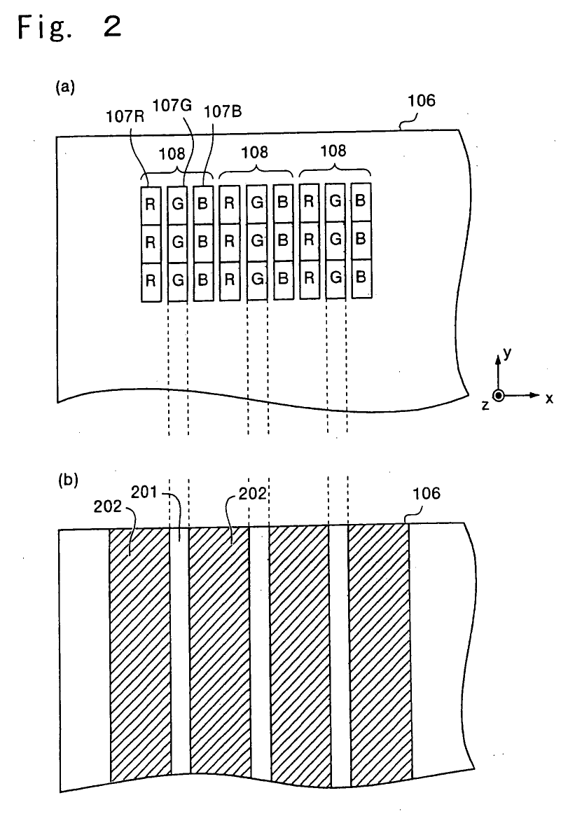

Next, the relationship between the fluorophors for respective colors, 107R, 107G, 107B and the openings 109 of the screen 106 will be described in conjunction with FIGS. 2(a) and (b). FIG. 2(a) is a schematic of the array of the fluorophors for the respective colors, 107R, 107G, 107B. One pixel 108 is formed of the fluorophor for the R light, 107R, the fluorophor for the G light, 107G, and the fluorophor for the B light, 107B each of which is rectangular. A plurality of pixels 108 are arrayed in a rectangular region on the second surface 106b. The fluorophors for the respective colored lights, 107R, 107G, 107B can be formed on the second surface 106b by coating which is based on ink-jet technology, printing technology or spin coating.

As shown in FIG. 2(b), belt-like openings 201 are provided at regular intervals in the first surface 106a of the screen 106. The openings 201 pass the first laser light from the WV laser light source for the R light, 101R or the UV laser light source for the G light, 101G therethrough so as to irradiate the fluorophor for the R light, 107R or the fluorophor for the G light, 107G which is the illuminant for the first colored light. They pass the second laser light from the UV laser light source for the B light, 101B therethrough so as to irradiate the fluorescence exchange substance for the B light 107B, which is the illuminant for the second colored light. Further, belt-like light shield portions 202 are provided iteratively at predetermined intervals sideward of the openings 201 on the first surface 106a. One opening 109 corresponds to one pixel 108. In this exemplary embodiment, one opening 201 is provided in correspondence with the position of the fluorophor for the G light, 107G in the pixel 108. The light shield portions 202 intercept the WV laser lights for the respective colored lights, by absorption or reflection. The light shield portions 202 can be formed of black plates, metallic thin films, a black resin, a black photosensitive resin, a black coating material, or the like.

The galvano-mirror. 103 scans the UV laser lights for the colored lights, from the WV laser light sources for the respective colored lights, 101R, 101G, 101B so that they may pass through the same positions near each opening 109. The UV laser lights for the colored lights, which enter the opening 109, are respectively different in the angles of entrance at which they enter the screen 106. The UV laser light for the R light enters only the fluorophor for the R light, 107R. Likewise, the WV laser light for the G light enters only the fluorophor for the G light, 107G. Further, the WV laser light for the B light enters only the fluorophor for the B light, 107B. Thus, in the scanning operation of the WV laser lights for the respective colored lights, it is dispensed with to perform strict positioning so that the fluorophors for the colored lights, 107R, 107G, 107B themselves may be precisely irradiated, respectively. Therefore, the UV laser light for the R light, for example, is scanned so that, when it passes through the opening 109, neither of the fluorophor for the G light, 107G and the fluorophor for the B light, 107B may be irradiated therewith. The same holds true of the UV laser light sources for the G light and the B light. Accordingly, the UV laser lights for the colored lights may be scanned so as to merely pass through the opening 109. As a result, an image of favorable color reproduction can be obtained with ease.

Modified Exemplary Embodiment of Light Shield Portions

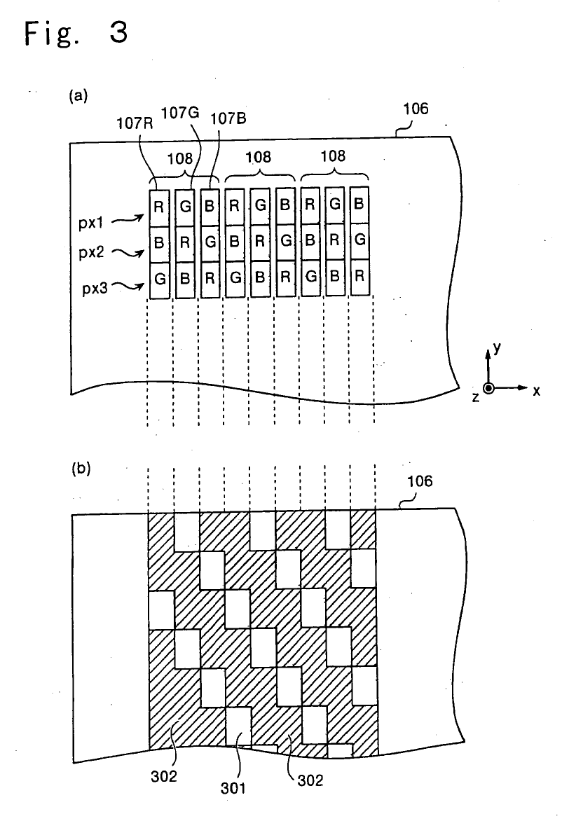

Next, the first modification of the array of the fluorophors for the respective colored lights, 107R, 107G, 107B in each pixel 108 will be described with reference to FIGS. 3(a) and (b). Referring to FIG. 3(a), each pixel 108 of a first row PX1 is such that, as in the first exemplary embodiment described above, the fluorophor for the R light, 107R, the fluorophor for the G light, 107G and the fluorophor for the B light, 107B are arrayed in the order from the left side of the drawing. In contrast, each pixel 108 of a second row PX2 is such that the fluorophor for the B light, 107B, the fluorophor for the R light, 107R and the fluorophor for the G light, 107G are arrayed in the order from the left side of the drawing. Further, each pixel 108 of a third row PX3 is such that the fluorophor for the G light, 107G, the fluorophor for the B light, 107B and the fluorophor for the R light, 107R are arrayed in the order from the left side of the drawing. In the array shown in FIG. 2(a), when note is taken of the relationship of the fluorophors for the colored lights, 107R, 107G, 107B in a vertical direction (y-axial direction), the fluorophors for the same colored lights are arrayed. Therefore, the opening 201 which is provided in correspondence with the position of, for example, the fluorophor for the G light, 107G has a belt shape as shown in FIG. 2(b). In contrast, in this modification, when note is taken of the relationship in a vertical direction (y-axial direction) in FIG. 3(a), the fluorophors for the colored lights, 107R, 107G, 107B are alternately arrayed. As shown in FIG. 3(b), therefore, openings 301 are formed at positions shifted stepwise as are the positions of the fluorophor for the G light, 107G in the individual pixels 108. Besides, light shield portions 302 are provided at the peripheral parts of the openings 301. This modification brings forth the advantage that lines of identical colors are not formed in the vertical direction (y-axial direction).

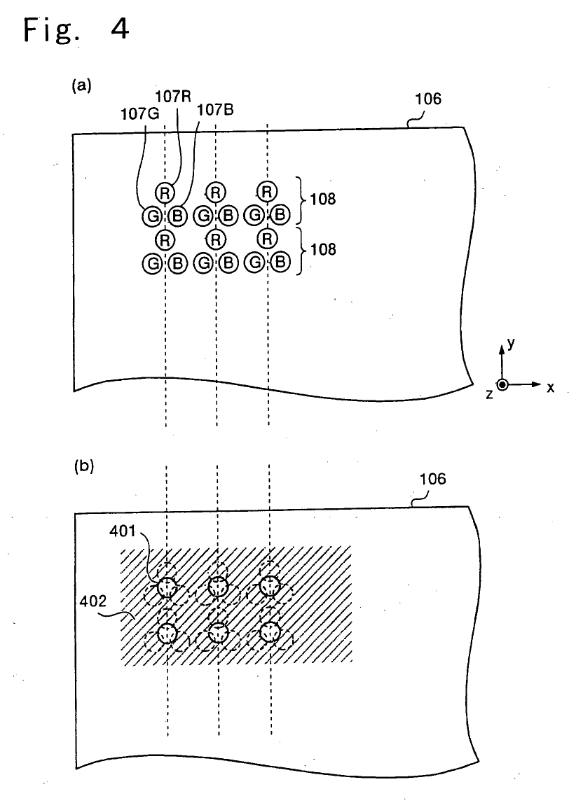

Next, the second modification of the array of the fluorophors for the respective colored lights, 107R, 107G, 107B in each pixel 108 will be described with reference to FIGS. 4(a) and (b). A point of difference is that, in the first exemplary embodiment and the first modification, each of the fluorophors for the individual colored lights, 107R, 107G, 107B has a rectangular-shape, whereas in the second modification, it has a circular shape. The circular fluorophors for the individual colored lights, 107R, 107G, 107B are formed in an array in which the central positions of respective circles coincide with the position of the apices of a triangle, that is, in a so-called “delta array”. As shown in FIG. 4(b), each opening 401 has a circular shape, and it is provided at substantially the central position of the fluorophors for the individual colored lights, 107R, 107G, 107B formed in a triangular shape.

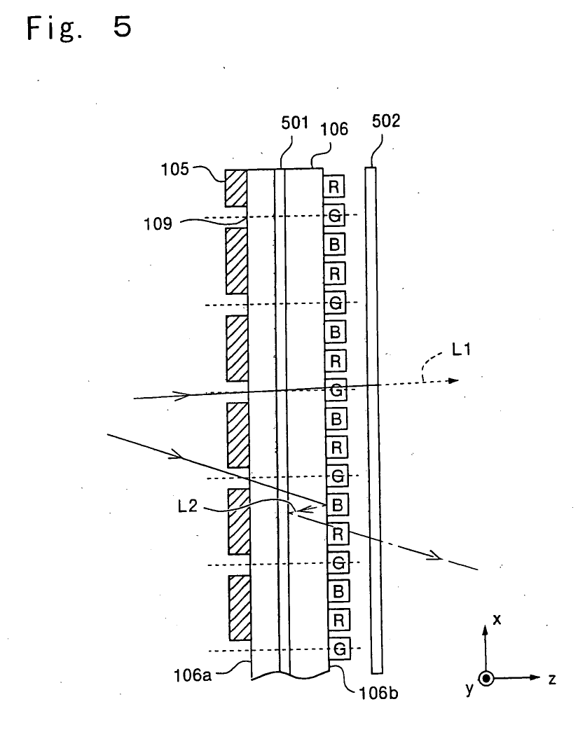

Next, the more detailed construction of the screen 106 will be described in conjunction with FIG. 5. FIG. 5 shows the section of the screen 106 on an enlarged scale. The UV laser lights for the individual colored lights should desirably have all their light quantities used to generate the fluorescences when the fluorophors for the respective colored lights, 107R, 107G, 107B are irradiated therewith. In some cases, however, parts of the UV laser lights are directly transmitted after having irradiated the fluorophors for the respective colored lights, 107R, 107G, 107B, and they exit from the side of the second surface 106b toward the observer just as, for example, UV laser light L1 indicated by a broken line. It is unfavorable from the viewpoint of safety that the UV laser light L1 enters the field of view of the observer. Therefore, a laser-light cutting filter 502 is disposed on the exit side of the fluorophor for the R light, 107R and the fluorophor for the G light, 107G which are the illuminants for the first colored lights, and the fluorophor for the B light, 107B which is the illuminant for the second colored light. The laser-light cutting filter 502 absorbs or reflects the UV laser light for the R light and the laser light for the G light, as are the first laser lights, and the UV laser light for the B light, as is the second laser light. It transmits the R light and G light, which are the first colored lights, and the B light, which is the second colored light. Thus, the R light, G light and B light which are necessary for the display of the full-color image are caused to exit from the side of the second surface 106b of the screen 106. The UV laser lights for the respective colored lights can be prevented from exiting from the screen 106.

The screen 106 further includes a dichroic film 501 between the first surface 106a and the second surface 106b. The dichroic film 501 transmits the UV laser light for the R light and the UV laser light for the G light, as are the first laser lights, and the UV laser light for the B light, as is the second laser light. It reflects the R light and G light, being the first colored lights, and the B light, being the second colored light, as have been generated toward the first surface 106a, toward the second surface 106b. The fluorescences from the fluorophors for the respective colored lights, 107R, 107G, 107B are generated, not only in the sense of exiting from the side of the second surface 106b of the screen 106, but also toward the first surface 106a being an entrance surface, just as, for example, the B light L2 indicated by a dot-and-dash line. The B light L2, and the G light and R light (neither of which is shown) as have been generated toward the first surface 106a do not exit onto an observer side which is the side of the second surface 106b of the screen 106, so that the losses of the light quantities occur. In contrast, in this exemplary embodiment, the above dichroic film 501 is disposed between the first surface 106a and the second surface 106b. The dichroic film 501 reflects the B light L2, and the G light and R light (neither of which is shown) as have been generated toward the first surface 106a, toward the second surface 106b. Thus, the R light, G light and B light can be effectively caused to exit from the side of the second surface 106b. The dichroic film 501 transmits the UV laser lights for the individual colored lights. Therefore, the UV laser lights for the individual colored lights can be efficiently caused to enter the fluorophors for the respective colored lights, 107R, 107G and 107B.

Moreover, since the screen 106 of the construction as shown in FIG. 5 can be easily manufactured, the yield thereof is enhanced. As a result, the screen 106 of large screen can be manufactured inexpensively.

By way of example, the dichroic film 501 can be simply formed by sealing it between two parallel plates of glass.

Second Exemplary Embodiment

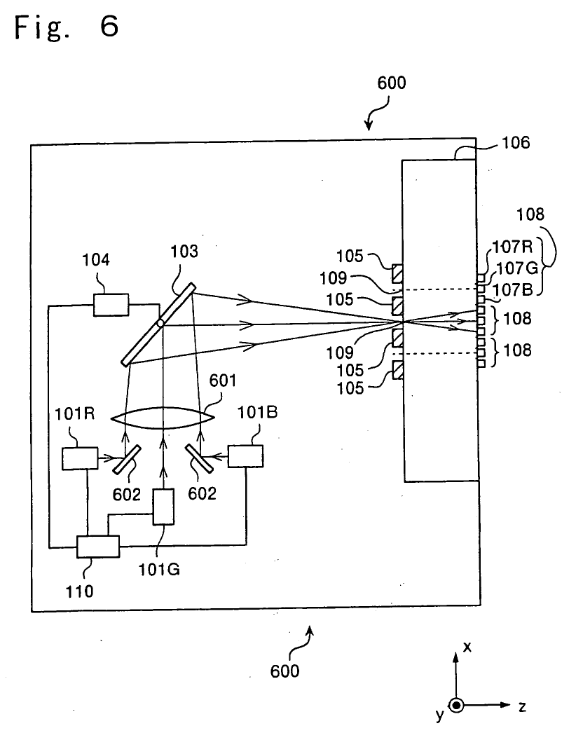

FIG. 6 shows the schematic construction of an image display device 600 according to the second exemplary embodiment of the present invention. The same reference numerals and signs are assigned to the same portions as in the first exemplary embodiment, and they shall be omitted from repeated description. UV laser light for R light, from a UV laser light source for the R light, 101R and UV laser light for B light, from a UV laser light source for the B light, 101B have their optical paths bent 90° by reflection mirrors 602, respectively, and they enter a condensing lens 601. UV laser light for G light, from a UV laser light source for the G light, 101G enters the condensing lens 601 directly. The condensing lens 601 is disposed at a position at which the UV laser lights for the respective colored lights are condensed near the openings 109 of a screen 106. The UV laser lights for the respective colored lights, as transmitted through the condensing lens 601, are scanned within a predetermined two-dimensional plane by a galvano-mirror 103. The R light, G light and B light are generated in the same way as in the first exemplary embodiment, whereby a full-color image can be obtained. This exemplary embodiment brings forth the advantage that the versatility of the arrangement of the UV laser light sources for the respective colored lights, 101R, 101G and 101B is high.

Modified Embodiment of Second Exemplary Embodiment

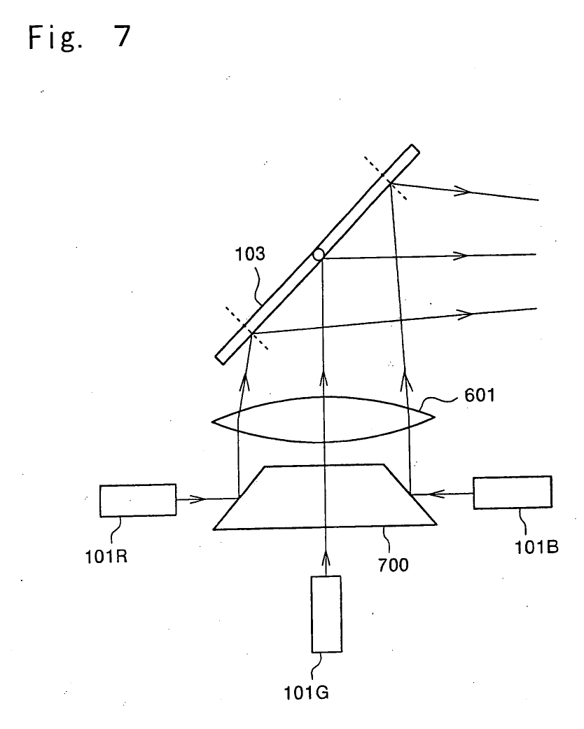

FIG. 7 shows part of the construction of the modification of the exemplary embodiment on an enlarged scale. In this modification, a trapezoidal prism 700 is employed instead of the two reflection mirrors 602. The UV laser light for the R light, from the W laser light source for the R light, 101R and the UV laser light for the B light, from the UV laser light source for the B light, 101B have their optical paths bent 90° by the oblique surfaces of the trapezoidal prism 700, respectively, and they enter the condensing lens 601. The UV laser light for the G light, from the UV laser light source for the G light, 101G enters the bottom surface of the trapezoidal prism 700 and exits from the top surface thereof, and it enters the condensing lens 601 directly. Thus, a construction in the vicinity of the laser light sources can be made small in size.

Third Exemplary Embodiment

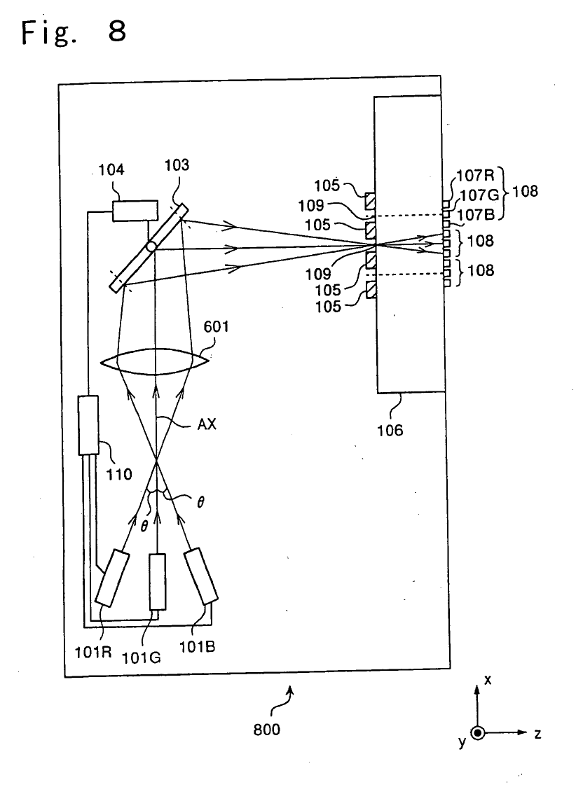

FIG. 8 shows the schematic construction of an image display device 800 according to the third exemplary embodiment of the present invention. The same reference numerals and signs are assigned to the same portions as in each of the foregoing exemplary embodiments, and they shall be omitted from repeated description. The UV laser light source for the G light, 101G emits the UV laser light for the G light, in a direction along the optical axis AX of the condensing lens 601. In contrast, the UV laser light source for the R light, 101R and the UV laser light source for the B light, 101B are arranged so that the UV laser light for the R light and the UV laser light for the B light may define a predetermined angle θ to the optical axis AX, respectively. Thus, any optical system for causing the laser lights to enter the condensing lens 601 is dispensed with, and a simple construction can be realized. Subsequently, the condensing lens 601 condenses the UV laser lights for the respective colored lights, near the openings 109. Condensing lenses may well be further disposed in the optical paths of the UV laser light sources for the individual colored lights, 101R, 101G 101B near the emission ends thereof, respectively. As in each of the foregoing exemplary embodiments, the UV laser lights for the respective colored lights enter the screen 106 and generate the R light, G light and B light, whereby a full-color image can be obtained.

Fourth Exemplary Embodiment

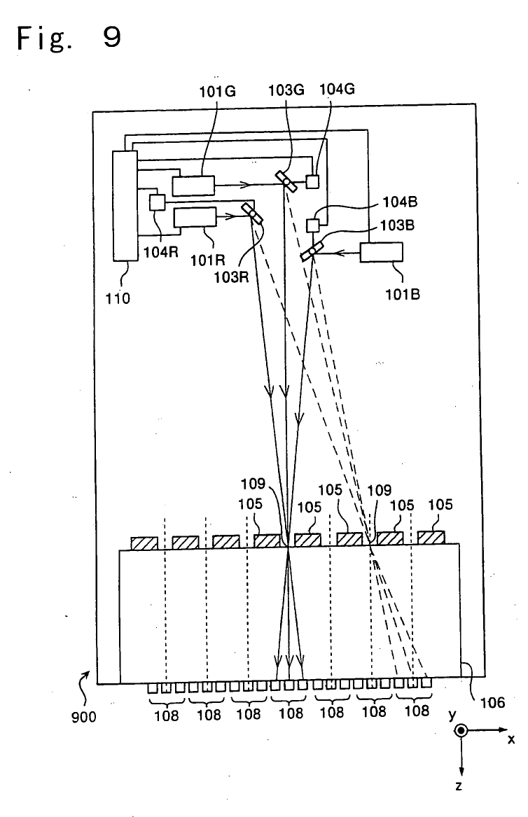

FIG. 9 shows the schematic construction of an image display device 900 according to the fourth exemplary embodiment of the present invention. The same reference numerals and signs are assigned to the same portions as in the first exemplary embodiment, and they shall be omitted from repeated description. The UV laser light for the R light, from the UV laser light source for the R light, 101R has its optical path bent and is scanned within a two-dimensional plane by a galvano-mirror for the R light, 103R. Likewise, the UV laser for the G light, from the UV laser light source for the G light, 101G and the UV laser light for the B light, from the UV laser light source for the B light, 101B have their optical paths bent and are scanned within the two-dimensional planes by a galvano-mirror for the G light, 103G and a galvano-mirror for the B light, 103B, respectively. The galvano-mirrors for the individual colored lights, 103R, 103G, 103B are independently driven by galvano-mirror drive portions for the individual colored lights, 104R, 104G, 104B, respectively.

As in each of the foregoing exemplary embodiments, the scanned UV laser lights for the respective colored lights enter the screen 106 and generate the R light, G light and B light. Thus, a full-color image can be obtained. In each of the foregoing exemplary embodiments, the UV laser lights for the respective colored lights are scanned by the single galvano-mirror 103. In this case, the galvano-mirror 103 sometimes becomes large in size. In this exemplary embodiment, the galvano-mirrors for the individual colored lights, 103R, 103G, 103B are disposed for the respective UV laser lights for the corresponding colored lights. Therefore, the galvano-mirrors for the respective colored lights, 103R, 103G, 103B can be arranged at spatially separate positions. When the galvano-mirrors for the respective colored lights, 103R, 103G, 103B are spatially separated, each of them can be made very small in size. By way of example, the galvano-mirrors for the respective colored lights, 103R, 103G, 103B can be formed by the technology of MEMS (Micro Electro Mechanical Systems). The individual galvano-mirrors constructed by the MEMS can be easily driven at high speed. Moreover, when the galvano-mirrors for the individual colored lights, 103R, 103G, 103B are independently disposed, the UV laser lights for the respective colored lights can be scanned independently and simultaneously. By way of example, image signals are appropriately rearranged, whereby the laser lights for the individual colored lights can be scanned so as to simultaneously pass through the openings 109 different from one another.

Fifth Exemplary Embodiment

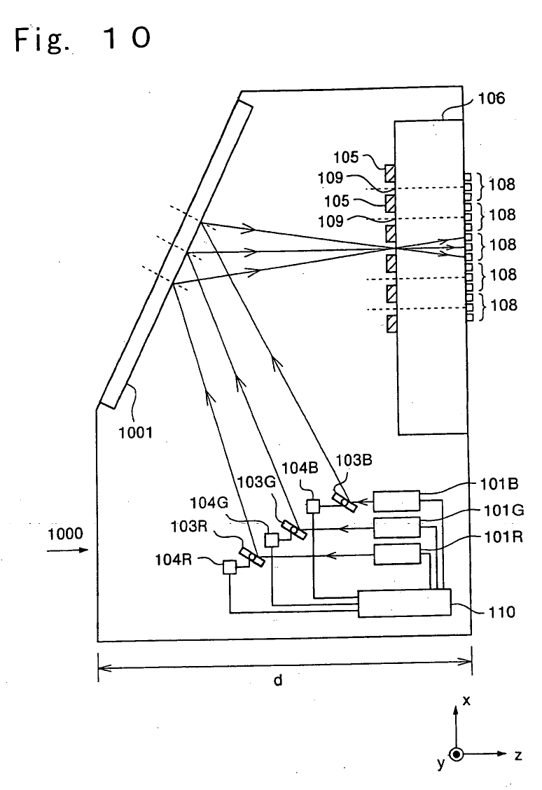

FIG. 10 shows the schematic construction of a rear projector 1000 according to the fifth exemplary embodiment of the present invention. The same reference numerals and signs are assigned to the same portions as in each of the foregoing exemplary embodiments, and they shall be omitted from repeated description. The UV laser light for the R light, from the UV laser light source for the R light, 101R has its optical path bent and is scanned within a two-dimensional plane by the galvano-mirror for the R light, 103R. Likewise, the UV laser light for the G light, from the UV laser light source for the G light, 101G and the UV laser light for the B light, from the UV laser light source for the B light, 101B have their optical paths bent and are scanned within the two-dimensional plane by the galvano-mirror for the G light, 103G and the galvano-mirror for the B light, 103B, respectively. The galvano-mirrors for the individual colored lights, 103R, 103G, 103B are independently driven by the galvano-mirror drive portions for the individual colored lights, 104R, 104G, 104B, respectively. The UV laser lights for the individual colored lights, which have been reflected and have had their optical paths bent owing to the galvano-mirror drive portions for the respective colored lights, 104R, 104G, 104B, are reflected toward the screen 106 again by a reflection mirror 1001. Besides, as in each of the foregoing exemplary embodiments, the UV laser lights for the respective colored lights enter the screen 106 and generate the R light, G light and B light. In this exemplary embodiment, the UV laser lights are reflected once by the reflection mirror 1001 so as to irradiate the screen 106. Therefore, the enlarged area of the screen 106 can be attained with the depth d of the rear projector 1000 made small. In the CRT of the related art, fluorophors are supplied with energy by employing an electron beam. The electron beam cannot be reflected by a reflection mirror. In contrast, the rear projector 1000 in this exemplary embodiment can have its depth d made still smaller by reflecting the UV laser lights by the reflection mirror, and further by reflecting them a plurality of times by a plurality of reflection mirrors.

In each of the foregoing exemplary embodiments, the fluorophors (which may be either organic or inorganic) are employed as the illuminants. However, they are not restrictive, but substances which generate phosphorescences or lights based on photoluminescent functions may well be employed. The wavelength region of the laser lights to supply energy to the illuminants is not restricted to the UV radiation region, but a visible radiation region or an infrared radiation region can be employed. Further, a scanning mechanism is not restricted to the galvano-mirror, but a construction in which an optical system such as a lens is combined with a movable mechanism or the like may well be employed.

1. A screen, comprising:
a first surface which a plurality of laser lights enter;
a second surface from which the plurality of laser lights exit;
a plurality of illuminants for a first colored light, which are irradiated with a first laser light of the plurality of laser lights, thereby to generate the first colored light in a first wavelength region;
a plurality of illuminants for second colored light, which are irradiated with a second laser light of the plurality of laser lights, thereby to generate the second colored light in a second wavelength region different from the first wavelength region;
the plurality of illuminants for the first colored light and the plurality of illuminants for the second colored light being alternately arrayed on the second surface;
openings which are formed on the first surface, which pass the first laser light therethrough so as to irradiate the illuminants for the first colored light, and which pass the second laser light therethrough so as to irradiate the illuminants for the second colored light; and
light shield portions which are provided at peripheral parts of the openings on the first surface so as to intercept the first laser light and the second laser light.

2. The screen as defined in claim 1, further comprising:
a laser-light cutting filter disposed on an exit side of the illuminants for the first colored light and the illuminants for the second colored light, which absorbs or reflects the first laser light and the second laser light, and which transmits the first colored light and the second colored light therethrough.

3. The screen as defined in claim 1, further comprising:
a dichroic film which is interposed between the first surface and the second surface, which transmits the first laser light and the second laser light therethrough, and which reflects the first colored light and the second colored light generated toward the first surface, toward the second surface.

4. The screen as defined in claim 1, the first colored light being red light and green light, the second colored light being blue light.

5. An image display device, comprising:
a first laser light source which supplies a first laser light modulated in accordance with an image signal;
a second laser light source which supplies a second laser light modulated in accordance with an image signal;
a scanning portion which scans at least one of the first laser light and the second laser light within a two-dimensional plane; and
the screen according to claim 1.

6. The image display device according to claim 5, the scanning portion including a first scanning portion which scans the first laser light, and a second scanning portion which scans the second laser light.

7. A rear projector, comprising:
a first laser light source which supplies a first laser light modulated in accordance with an image signal;
a second laser light source which supplies a second laser light modulated in accordance with an image signal;
a scanning portion which scans at least one of the first laser light and the second laser light within a two- dimensional plane;
a reflection mirror which reflects the scanned laser light; and
the screen according to claim 1, and which is irradiated with the laser light reflected by the reflection mirror.
